(19) United States
(12) Patent Application Publication
(10) Pub. No.: US 2015/0291463 A1
(43) Pub. Date: Oct. 15, 2015

(54) APPARATUS AND METHOD FOR DESALINATING SEAWATER

(71) Applicant: Zhongying Changjiang International New Energy Investment Co., Ltd., Wuhan (CN)

(72) Inventors: Yilong CHEN, Wuhan (CN); Qingping YANG, Wuhan (CN); Yanfeng ZHANG, Wuhan (CN)

(21) Appl. No.: 14/749,672

(22) Filed: Jun. 25, 2015

Related U.S. Application Data
(63) Continuation-in-part of application No. PCT/CN2013/087184, filed on Nov. 15, 2013.

(30) Foreign Application Priority Data
Dec. 25, 2012 (CN) 201210569476.8

(51) Int. Cl. C02F 9/00; B01D 3/06; C02F 1/52; C02F 1/50; C02F 1/14; C02F 1/06

(52) U.S. Cl. CPC C02F 9/00; C02F 1/14; C02F 1/06; C02F 1/52; C02F 1/50; B01D 3/06; C02F 2103/08

(57) ABSTRACT

An apparatus for desalinating seawater, including: a seawater purifying system and a seawater desalinating system. The seawater purifying system includes: a purified seawater transporting pump including a purified seawater output main pipe. The seawater desalinating system includes: a solar thermal apparatus for concentrating solar energy and collecting heat, a solar energy heat storage tank, a purified seawater heater, a heated seawater pump, at least one stage of seawater flash evaporator, a freshwater main pipe, a sealed fresh water storage tank, a vacuum pump, and a concentrated brine pump. The solar thermal apparatus includes a heat transfer medium chamber. The purified seawater heater includes: a first heat exchanger utilizing a heat transfer medium as a heat source, an inlet, a seawater outlet, and an inlet main pipe. Each stage of seawater flash evaporator includes a flash evaporator body and a seawater cooler.

### CROSS-REFERENCE TO RELATED APPLICATIONS

This application is a continuation-in-part of International Patent Application No. PCT/CN2013/087184 with an international filing date of Nov. 15, 2013, designating the United States, now pending, and further claims priority benefits to Chinese Patent Application No. 201210569476.8 filed Dec. 25, 2012. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to an apparatus and a method for desalinating seawater.

2. Description of the Related Art

Shortage of freshwater resource has become a serious problem. Freshwater can be acquired by distilling seawater but, conventionally, this has been an inefficient process.

### SUMMARY OF THE INVENTION

In view of the above-described problems, it is one objective of the invention to provide an apparatus and a method for desalinating seawater using solar energy.

The apparatus and the method of the invention are capable of continuously producing freshwater much environmentally friendly in the coastal regions or in inland brackish water regions to solve the freshwater scarcity.

To achieve the above objective, in accordance with one embodiment of the invention, there is provided an apparatus for desalinating seawater, comprising: a seawater purifying system and a seawater desalinating system. The seawater purifying system comprises: a purified seawater transporting pump; the purified seawater transporting pump comprises a purified seawater output main pipe. The seawater desalinating system comprises: a solar thermal apparatus for concentrating solar energy and collecting heat, a solar energy heat storage tank, a purified seawater heater, a heated seawater pump, at least one stage of seawater flash evaporator, a freshwater main pipe, a sealed fresh water storage tank, a vacuum pump, and a concentrated brine pump. The solar thermal apparatus comprises a heat transfer medium chamber. The purified seawater heater comprises: a first heat exchanger utilizing a heat transfer medium as a heat source, an inlet, a seawater outlet, and an inlet main pipe. Each stage of seawater flash evaporator comprises a flash evaporator body and a seawater cooler. The flash evaporator body comprises: a concentrated brine outlet, a freshwater outlet, and a vapor outlet, a throttling device comprising an inlet, and a condenser body comprising a seawater outlet. The seawater cooler comprises: a second heat exchanger utilizing vapor as a heat source, and a seawater outlet. The heat transfer medium chamber of the solar thermal apparatus, solar energy heat storage tank, the first heat exchanger of the purified seawater heater are connected in sequence to form a sealed route for circulating the heat transfer medium. The purified seawater output main pipe of the purified seawater transporting pump communicates with the inlet of the purified seawater heater and the seawater cooler. The seawater outlet of the purified seawater heater communicates with the inlet of the throttling device of the first-stage flash evaporator body via the heated seawater pump. Vapor discharged from the vapor outlet of the flash evaporator body passes through the second heat exchanger and combines with a freshwater in the freshwater main pipe. The sealed fresh water storage tank is disposed at an end of the freshwater main pipe and communicates with the vacuum pump. The concentrated brine outlet communicates with a pipe of a salt plant via the concentrated brine pump. The seawater outlet of the seawater cooler communicates with the inlet main pipe of the purified seawater heater via the condenser body of the flash evaporator body. When at least two stage seawater flash evaporators are employed, the purified seawater output main pipe communicates with the seawater outlets of the condenser bodies of each stage seawater flash evaporator. The concentrated brine outlet of a former stage flash evaporator body communicates with the inlet of the throttling device of a next stage flash evaporator body, and the concentrated brine outlet of a last stage flash evaporator body communicates with the pipe of the salt plant via the concentrated brine pump. Pressures in the flash evaporator bodies of each stage are gradually decreased whereby forming negative pressures.

In a class of this embodiment, a heated seawater pump having adjustable rotational speed is disposed between the seawater outlet of the purified seawater heater and the flash evaporator body. The seawater outlet of the purified seawater heater communicates with the throttling device disposed on the flash evaporator body via the heated seawater pump, and the throttling device is disposed above a seawater surface in the flash evaporator body. In the flash evaporator body, a foam breaker is disposed above the throttling device, a freshwater collecting disc is disposed above the foam breaker, and the condenser body is disposed on the freshwater collecting disc. The vapor outlet is disposed at a top of the flash evaporator body, and the freshwater outlet is disposed above the freshwater collecting disc, and the concentrated brine outlet is disposed beneath the throttling device.

In a class of this embodiment, a seawater temperature sensor and a spare heat exchanger are disposed in the purified seawater heater; and the spare heat exchanger adopts a thermal oil furnace, an electric heating furnace, exhaust heat of flue gas from a boiler, or exhaust heat of waste heat from a turbine as a heat source.

In a class of this embodiment, a heat transfer medium pump is disposed between the solar energy heat storage tank and the first heat exchanger of the purified seawater heater.

In a class of this embodiment, the solar power filed is a tower type solar thermal collector, a parabolic trough type evacuated tubular collector, a glass type evacuated tubular collector, or a heat pipe type evacuated tubular collector.

In a class of this embodiment, the seawater purifying system is a multi-stage purifying system comprising a seawater extraction well for coarse filtration, a seawater sterilizing clarifier, a multi-stage ultra-filter provided with an active carbon filter layer and a multi-fiber filter core layer, and a deoxygenating-decarbonizing tower for deoxygenation and decarbonization arranged in sequence. A purified seawater tank is disposed between the multi-stage ultra-filter and the deoxygenating-decarbonizing tower. The deoxygenating-decarbonizing tower communicates with a purified seawater main outlet. The seawater extraction well communicates with the seawater sterilizing clarifier via a seawater lifting pump. The seawater sterilizing clarifier communicates with the multi-stage ultra-filter via a first seawater transporting pump. The multi-stage ultra-filter communicates with the purified seawater tank via a second seawater transporting pump. The purified seawater tank communicates with the deoxygenating-decarbonizing tower via a third seawater transporting pump. The deoxygenating-decarbonizing tower communicates with the purified seawater main outlet via a purified seawater pump. The seawater sterilizing clarifier is added with a microbicide and a flocculant.

In a class of this embodiment, the seawater extraction well is constructed at a sea beach. A well opening is disposed above a sea level at the highest tide, and a well bottom is disposed multiple meters beneath a sea level at low tides. A well wall adopts a porous concrete structure, rubbles are arranged outside the well wall, and sands are filled in the periphery of the rubbles.

In accordance with another embodiment of the invention, there is provide a method for desalinating seawater using the above seawater desalinating apparatus, the method comprising: multi-stage purifying the seawater to produce a purified seawater; collecting solar energy by the solar thermal apparatus to heat the heat transfer medium whereby converting the solar energy into heat energy of the heat transfer medium; continuously heating the purified seawater to a preset temperature by the heat energy of the heat transfer medium, and transporting the heated purified seawater to at least one-stage flash evaporator for flash evaporation; allowing pressures in the flash evaporator bodies of each stage to gradually decrease to form a negative pressure during the flash evaporation; condensing a vapor after the flash evaporation to separate the freshwater, and converting remaining vapor into the freshwater by the seawater cooler; and transporting a non-vaporized concentrated brine from a bottom of the flash evaporator to the salt plant. When multi-stage flash evaporators are employed, the concentrated brine at the bottom of the former stage flash evaporator successively flow into a next stage flash evaporator, and the freshwater is gradually condensed and separated out during the multi-stage evaporation process, and the non-vaporized concentrated brine is transported to the salt plant. At the same time the heat energy of the sunlight is collected by the solar thermal apparatus and the heat transfer medium is utilized to heat the purified seawater, the heat energy of the heat transfer medium is stored in the solar energy heat storage tank so as to continuously heat the purified seawater using the stored heat transfer medium during nocturnal periods or cloudy days.

In a class of this embodiment, the preset temperature of the purified seawater heated by the heat transfer medium is 55-70° C. or 70-120° C., and the heat transfer medium is heated to a temperature of 178-600° C. by the solar thermal apparatus.

In a class of this embodiment, the preset temperature of the purified seawater heated by the heat transfer medium is ±70° C., and the heat transfer medium is heated to the temperature of 275-395° C. by the solar thermal apparatus.

The solar energy heat storage tank is designed for the purpose of maintaining a stable output of the heat energy of the solar power in nocturnal periods and cloudy days as well as continuously supplying freshwater to civil use or industrial use for 24 hrs. The function of the solar energy heat storage tank is storing the solar energy during daytime as much as possible and using the stored solar energy during the night.

The seawater extraction well is constructed in a sea beach, a position of a well opening being above the sea level at the highest tide, a well depth is several meters lower than the sea level at the lowest tide, the diameter of the well satisfies the extracted seawater volume. Thus, the seawater accommodated in the well has been preliminarily naturally filtered by the sands of the beach thereby being excluded from marine organisms and impurities. In addition, since the sea beach is washed every day by the seawater at the high tide and the low tide, the sea beach always keeps the natural cleaning and filtering functions. The method for constructing a well on the beach is that a well wall adopts porous concrete structure with multiple pores, rubbles are arranged in the periphery of the well wall, and sands of the beach are filled outside the rubbers.

The seawater sterilizing clarifier is added with a microbicide (such as chlorine) for killing planktons, microbes, or bacteria in the seawater, and then added with the flocculant (such as FeCl₂ and alum) so as to precipitate mass substances and clarify the seawater. A supernatant in the upper part of the clarifier is transferred by the first seawater transporting pump to the multi-stage ultra-filter where the supernatant is treated with multi-stage ultra-filtration and a purified seawater is then stored in the purified seawater tank. Sediments in the bottom of the seawater sterilizing clarifier (beneath the inlet of the first seawater transporting pump) is required to be flushed and cleaned periodically (using a small volume of purified seawater) to discharge sewage to a wastewater treatment plant. The multi-stage ultra-filter is also periodically backwashed by seawater so as to recover the cleaning and filtering functions of each filter layer.

When the seawater desalinating system is started, the purified seawater is driven by the seawater pump to enter the deoxygenating-decarbonizing tower to remove oxygen and CO₂ therein because that the seawater generally contains 3.5 wt. % of salts and has strong corrosivity, and the existence of the oxygen and CO₂ facilitates the corrosion of the seawater on the apparatus.

The purified seawater heater comprises a heating container, and the first heat exchanger and a spare heat exchanger disposed in the heating container. The first heat exchanger is employed for the purpose of heating the seawater to a certain temperature, thus, the purified seawater heater is also provided with the seawater temperature sensor for measuring the temperature of the heated seawater. However, in conditions of successive cloudy or rainy days, it may be difficult to ensure 24 hrs of continuous freshwater supplying, thus, the purified seawater heater is provided with the spare heat exchanger, and various auxiliary heat sources (such as thermal oil furnace, electric heating furnace, exhaust heat of flue gas from boilers, and exhaust heat of waste heat from turbines) are employed to heat the seawater in cloudy rainy seasons so as to continuously produce the freshwater.

The flash evaporator comprises the flash evaporator body and the seawater cooler. The flash evaporator body comprises: the throttling device, the foam breaker, and the freshwater collecting disc bottom-up. The arrangement of the throttling device on the flash evaporator body enables the pressure of the seawater to sharply decrease when entering the flash evaporator. A large amount of the seawater is evaporated. During the raise of the vapor, large seawater drops carried in the vapor is obstructed by the foam breaker (the foam breaker is made of steel wire meshes with small areolae, such as 200-mesh, 300-mesh, or 400-mesh, the material is anticorrosive, such as stainless steel, titanium alloy wire, or carbon fibers). The vapor passing through the foam breaker reaches the condenser body where one part of the vapor is condensed into the freshwater and fall into the freshwater collecting disc and is transported to the freshwater tank, while the other part of the vapor passes through the top of the flash evaporator and enters the seawater cooler where the vapor is condensed again because the seawater is sprayed onto the second heat exchanger in the seawater cooler, thus, the latent heat is further released, and the condensed freshwater is transported to the freshwater tank.

The multi-stage flash evaporator comprises N signal stage flash evaporators. N is a positive integer. The freshwater output pipe of each single stage flash evaporator communicates with the sealed freshwater storage tank via a freshwater main pipe. An inlet pipe of the vacuum pump is connected to a top of the sealed freshwater storage tank, so that pressures in each stage flash evaporator gradually decrease to form a negative pressure during the operation of the vacuum pump, and the heated seawater in each stage flash evaporator tends to be vaporized. The produced vapor releases the latent heat and is condensed into the freshwater when it transfers heat with relatively cold seawater. The concentrated seawater in the bottom of each flash evaporator is gradually cooled and flows into the next stage flash evaporator where the concentrated seawater is flash vaporized and then condensed into the freshwater while the remaining un-vaporized concentrated brine is transported to the salt plant.

Advantages according to embodiments of the invention are summarized as follows:

First, the high efficient solar thermal apparatus is utilized to heat the heat transfer medium (such as the conduction oil, the silicone oil, the paraffin wax, and the molten salt), and the heat transfer medium is then employed to heat the purified seawater to a preset temperature. Thus, the scale formation resulted from seawater heating directly by the solar thermal apparatus is avoided, the seawater desalinating system is enabled to operate at the best temperature parameters, and the solar thermal apparatus is also enable to operate at its best parameters (the heat transfer medium is heated to 275-395° C. or 178-600° C.), thereby realizing efficiency for collecting the heat energy of the solar power to the utmost.

Second, the freshwater plant is generally required to continuously supply water for 24 hrs. The heat energy of the sunlight is stored by the heat transfer medium, so that the seawater can be heated in nocturnal periods, and the freshwater is continuously produced.

Third, the seawater is evaporated by combining the multi-stage flash evaporator structure with the solar thermal apparatus. The desalinating rate of the seawater reaches 40%, and the solar energy can be stored to enable the seawater desalinating apparatus to continuously operate to produce the freshwater in nocturnal periods. The produced freshwater has good quality and reaches the standard of drinking water. Furthermore, the green solar energy is primarily utilized, so that the seawater desalinating process is environmentally friendly, high efficient with high yield.

### BRIEF DESCRIPTION OF THE DRAWINGS

The invention is described hereinbelow with reference to the accompanying drawings, in which:

FIG. 1 is a structure diagram of an apparatus for desalinating seawater using solar energy for continuously supplying heat according to one embodiment of the invention; and

FIG. 2 is a structure diagram of a local part of a seawater extraction well according to one embodiment of the invention.

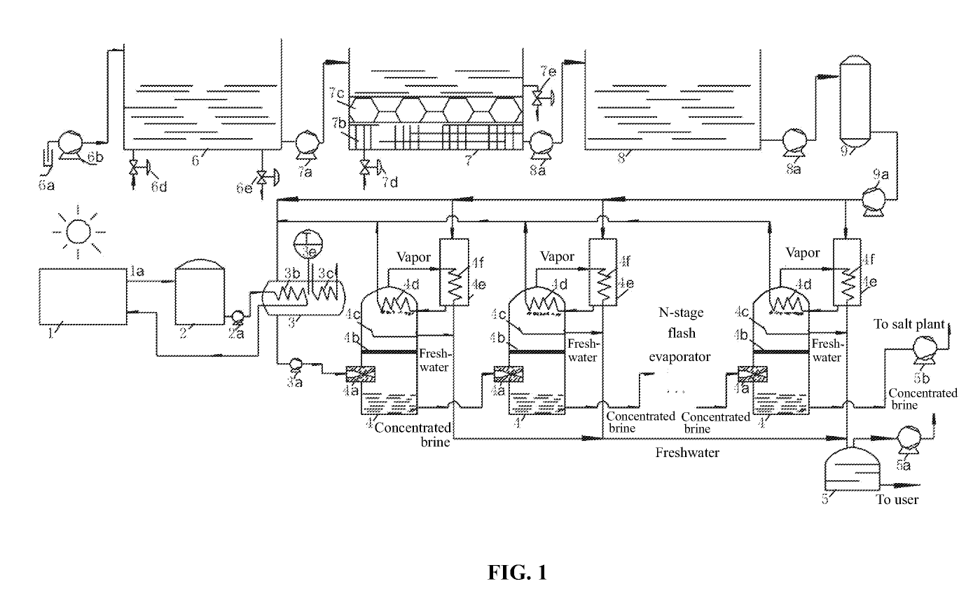

In FIG. 1, 1 is a solar thermal field for concentrating solar energy and collecting heat, la is a delivery main pipe of the solar thermal field, a heat transfer medium is accommodated in the main pipe. 2 is a solar heat storage tank, 2a is a heat transfer medium pump. 3 is a seawater heater, 3b is a heat exchanger using the heat transfer medium, 3a is a heated seawater pump with adjustable rotational speed, and T3e is a temperature sensor disposed in the seawater heater 3. 4 is a single-stage flash evaporator, N represents a positive integer, when N=1, the flash evaporator is a 1-stage flash evaporator; when N=2, the flash evaporator is a 2-stage flash evaporator, and similarly N refers to a N-stage flash evaporator. Generally, N=3-9, and when N=9 in a best mode to carry out the invention, the last at the most right side is the 9-stage flash evaporator. 4a is a throttling device disposed in a bottom of the flash evaporator, 4b is a foam breaker, and 4c is a freshwater collecting disc, 4d is a condenser body, 4e is a seawater cooler, and a vapor heat exchanger 4f is disposed therein. 5 is a sealed freshwater storage tank, a top of the tank is connected to a vacuum pump 5a via a pipe. 5b is a concentrated brine pump disposed at a concentrated brine output pipe of the flash evaporator of the last stage. 6 is a seawater sterilizing clarifier, 6a is a seawater extraction well-constructed with a top above a highest sea level at high tides, a depth of the well is several meters lower than a sea level at low tides, and a diameter of the well is appropriate (which satisfies the extraction of a certain amount of seawater). 6b is a seawater lifting pump, 6d is a switch valve at a purified seawater inlet, and 6e is a blowoff valve of the seawater sterilizing clarifier 6 (when the switch valve 6d at the and the blowoff valve 6e are turned on, the purified seawater is introduced to the bottom of the seawater sterilizing clarifier 6 to flush a sludge, and an output pipe of the blowoff valve 6e communicates with a wastewater treatment plant). 7 is a multi-stage ultra-filter, 7b is an active carbon filter layer, 7c is a multi-fiber filter core layer, 7d is a first backwashing valve for introducing purified seawater, 7e is a second backwashing valve for discharging sludge (the first backwashing valve 7d and the second backwashing valve 7e are periodically opened to introduce the purified seawater to blush the filter layers within the multi-stage ultra-filter 7 so as to recover the cleaning and filtering functions of each filter layer). 8 is a purified seawater tank, 9 is a deoxygenating-decarbonizing tower, 7a, 8a are seawater transporting pumps, and 9a is a purified seawater pump.

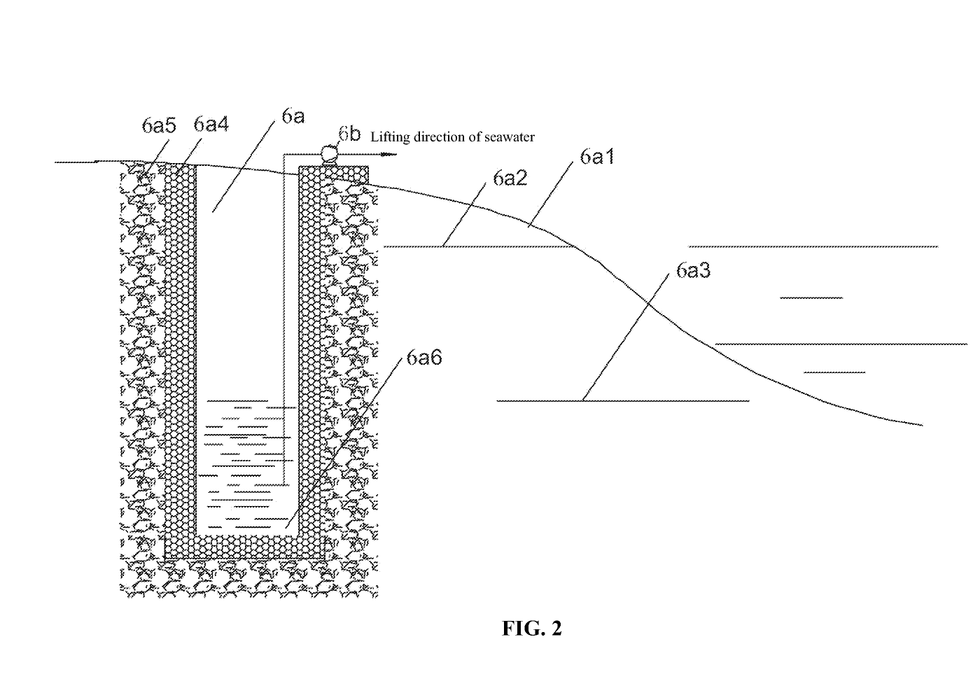

As shown in FIG. 2, 6b is a seawater lift pump, 6a is a seawater extraction well, 6a1 is a seaside beach, 6a2 is a highest sea level at high tide, 6a3 is a lowest sea level, 6a4 is a porous concrete wall, 6a5 is rubbles, 6a6 is sea sand at a well bottom which will be elevated along with the time and are required to removed periodically.

### DETAILED DESCRIPTION OF THE EMBODIMENTS

For further illustrating the invention, experiments detailing an apparatus and a method for desalinating seawater are described below. It should be noted that the following examples are intended to describe and not to limit the invention.

As shown in FIGS. 1-2, an apparatus for desalinating seawater using solar energy for continuously supplying heat comprises: a seawater purifying system, and a seawater desalinating system. The seawater desalinating system comprises: a solar thermal apparatus 1 for concentrating solar energy and collecting heat, a solar energy heat storage tank 2, a purified seawater heater 3, and at least one stage of seawater flash evaporator. The seawater flash evaporator comprises: a flash evaporator body 4 and a seawater cooler 4e. A heat transfer medium chamber of the solar thermal apparatus 1, the solar energy heat storage tank 2, a first heat exchanger 3b of the purified seawater heater 3 utilizing a heat transfer medium as a heat source are connected in sequence to form a sealed route for circulating the heat transfer medium. A purified seawater output main pipe of a purified seawater transporting pump 9a in the seawater purifying system communicates with an inlet of the purified seawater heater 3 and the seawater cooler 4e. A seawater outlet of the purified seawater heater 3 communicates with an inlet of a throttling device 4a of the first-stage flash evaporator body via a heated seawater pump 3a. The flash evaporator body 4 comprises: a concentrated brine outlet, a freshwater outlet, and a vapor outlet. Vapor discharged from the vapor outlet passes through a second heat exchanger 4f of the seawater cooler 4e using vapor as a heat source and is accumulated with a freshwater in a freshwater main pipe. A sealed freshwater storage tank 5 disposed at an end of the freshwater main pipe communicates with a vacuum pump 5a. The concentrated brine outlet communicates with a pipe of a salt plant via a concentrated brine pump 5b. A seawater outlet of the seawater cooler 4e communicates with an inlet main pipe of the purified seawater heater 3 via a condenser body 4d of the flash evaporator body 4. When at least two stage seawater flash evaporators are employed, the purified seawater output main pipe of the purified seawater pump 9a in the seawater purifying system communicates with the seawater outlets of the condenser bodies 4d of each stage seawater flash evaporator. The concentrated brine outlet of a former stage flash evaporator body 4 communicates with an inlet of the throttling device 4a of a next stage flash evaporator body 4, and the concentrated brine outlet of a last stage flash evaporator body 4 communicates with the pipe of the salt plant via the concentrated brine pump 5b. Pressures in the flash evaporator bodies 4 of each stage are gradually decreased whereby forming negative pressures.

The seawater purifying system is a multi-stage purifying system comprising a seawater extraction well 6a for coarse filtration, a seawater sterilizing clarifier 6, a multi-stage ultra-filter 7 provided with an active carbon filter layer and a multi-fiber filter core layer, and a deoxygenating-decarbonizing tower 9 for deoxygenation and decarbonization. A purified seawater tank 8 is disposed between the multi-stage ultra-filter 7 and the deoxygenating-decarbonizing tower 9. The deoxygenating-decarbonizing tower 9 communicates with a purified seawater main outlet. The seawater extraction well 6a communicates with the seawater sterilizing clarifier 6 via a seawater lifting pump 6b. The seawater sterilizing clarifier 6 communicates with the multi-stage ultra-filter 7 via a first seawater transporting pump 7a. The multi-stage ultra-filter 7 communicates with the purified seawater tank 8 via a second seawater transporting pump 8a. The purified seawater tank 8 communicates with the deoxygenating-decarbonizing tower 9 via a third seawater transporting pump 8a. The deoxygenating-decarbonizing tower 9 communicates with the purified seawater main outlet via a purified seawater pump 9a. The seawater sterilizing clarifier 6 is added with a microbicide and a flocculant.

A method for desalinating seawater by applying the above seawater desalinating apparatus comprises: multi-stage purifying the seawater to produce a purified seawater; collecting solar energy by the solar thermal apparatus to heat the heat transfer medium whereby converting the solar energy into heat energy of the heat transfer medium; continuously heating the purified seawater to a preset temperature by the heat energy of the heat transfer medium, and transporting the heated purified seawater to at least one-stage flash evaporator for flash evaporation; allowing pressures in the flash evaporator bodies of each stage to gradually decrease to form a negative pressure during the flash evaporation; condensing a vapor after the flash evaporation to separate the freshwater, and converting remaining vapor into the freshwater by the seawater cooler; and transporting a non-vaporized concentrated brine from a bottom of the flash evaporator to the salt plant.

When multi-stage flash evaporators are employed, the concentrated brine at the bottom of the former stage flash evaporator successively flow into a next stage flash evaporator, and the freshwater is gradually condensed and separated out during the multi-stage evaporation process, and the non-vaporized concentrated brine is transported to the salt plant. At the same time the heat energy of the sunlight is collected by the solar thermal apparatus and the heat transfer medium is utilized to heat the purified seawater, the heat energy of the heat transfer medium is stored in the solar energy heat storage tank so as to continuously heat the purified seawater using the stored heat transfer medium during nocturnal periods or cloudy days.

The preset temperature of the purified seawater heated by the heat transfer medium is 55-70° C. or 70-120° C., and the heat transfer medium is heated to a temperature of 178-600° C. by the solar thermal apparatus.

The preset temperature of the purified seawater heated by the heat transfer medium is ±70° C., and the heat transfer medium is heated to the temperature of 275-395° C. by the solar thermal apparatus.

To desalt the seawater using the seawater desalinating device continuously supplied with heat by the solar energy, the seawater lift pump 6b was firstly started, and the seawater is extracted from the seawater extraction well 6a and fed to the seawater sterilizing clarifier 6. The seawater extraction well 6a is constructed in a sea beach, a position of a well opening being above the sea level at the highest tide 6a2, and a well depth is lower than the sea level at the lowest tide 6a3, so that the seawater accommodated in the well has been preliminarily naturally filtered by the sands of the beach thereby being excluded from marine organisms and impurities. In addition, since the sea beach is washed every day by the seawater at the high tide and the low tide, the sea beach always keeps the natural cleaning and filtering functions. The method for constructing a well on the beach is that a well wall adopts porous concrete structure 6a4 with multiple pores, rubbles 6a5 are arranged in the periphery of the well wall, and sands of the beach are filled outside the rubbers.

The seawater sterilizing clarifier 6 is added with a microbicide (such as chlorine) for killing planktons, microbes, or bacteria in the seawater, and then added with the flocculant (such as FeCl₂ and alum) so as to precipitate mass substances and clarify the seawater. A supernatant in the upper part of the clarifier is transferred by the first seawater transporting pump 7a to the multi-stage ultra-filter 7 where the supernatant is treated with multi-stage ultra-filtration and a purified seawater is then stored in the purified seawater tank 8. Sediments in the bottom of the seawater sterilizing clarifier 6 (beneath the inlet of the first seawater transporting pump) is required to be flushed and cleaned periodically (using a small volume of purified seawater) to discharge sewage to a wastewater treatment plant. The multi-stage ultra-filter 7 is also periodically backwashed by seawater so as to recover the cleaning and filtering functions of each filter layer.

When the seawater desalinating system is started, the purified seawater is driven by the seawater pump 8a to enter the deoxygenating-decarbonizing tower 9 to remove oxygen and CO₂ therein because that the seawater generally contains 3.5 wt. % of salts and has strong corrosivity, and the existence of the oxygen and CO₂ facilitates the corrosion of the seawater on the apparatus.

During the seawater desalinating process, the solar energy collected by the solar thermal field 1 in diurnal periods is converted into heat energy of the heat transfer medium in the delivery main pipe 1a, and the heat energy is stored in the heat storage tank 2 via the heat transfer medium. The heat transfer medium 2 flows into the first heat exchanger 3b in the purified seawater heater 3 under the drive of a heat transfer medium pump 2a to heat the purified seawater (generally to a temperature of 55-120° C.). In this example, the temperature is preset to be 70° C. The heated seawater is driven by the heated seawater pump 3a and transported to a first-stage flash evaporator body 4 (the speed of the heated seawater pump is adjusted to control the flow rate of the seawater transported to the first-stage flash evaporator thereby controlling the seawater level in the flash evaporator body 4). Since the pressure in the flash evaporator body is negative, the pressure of the heated seawater is suddenly decreased when passing through the throttling device 4a and is transformed into vapor. During the raise of the vapor, large seawater drops carried in the vapor is obstructed by a foam breaker and fall down to the bottom of the flash evaporator body. The vapor rises to a top of the flash evaporator body and reaches the condenser body 4d to release a latent heat. A part of the vapor is condensed into freshwater which falls down in the freshwater collecting disc 4c and is accumulated into the sealed freshwater storage tank via pipes, and the remaining non-condensed vapor enters the second heat exchanger 4f of the seawater cooler 4e where the vapor is cooled again by the seawater with relatively low temperature to release the latent heat, the condensed freshwater flows to a freshwater main pipe and is accumulated in the sealed freshwater storage tank. In the meanwhile, the concentrated brine in the bottom of the first-stage flash evaporator body automatically enters a second-stage flash evaporator body because the operation of the vacuum pump 5a arranged at a top of the sealed freshwater storage tank 5 forms a pressure difference between the first-stage flash evaporator body and the second-stage flash evaporator body. When the concentrated brine enters the second-stage flash evaporator, the freshwater production process from the throttling device 4a to the second heat exchanger 4f is repeated again. The above processes are repeated until the last stage flash evaporator body. The last stage is the ninth-stage flash evaporator. The concentrated brine from the last stage flash evaporator body is finally transported to the salt plant via the salt pump 5b for subsequent treatment. Thus, the seawater entering the first-stage flash evaporator is treated with nine stage evaporation processes, and approximately 40% of the seawater is condensed and converted into the freshwater.

The desalinating effect of the seawater is not always in positive correlation with the temperature. When the seawater is heated to 75-78° C., the salts in the seawater (sodium, calcium, magnesium ions) quickly form scales in the apparatus, affecting the heat transfer and decreasing the working efficiency thereof. The addition of antisludging agent into the seawater is capable of preventing scale formation even when the seawater is heated to 120° C., but it has to pay much cost to remove the antisludging agent therefrom in the subsequent. Thus, a best temperature parameter to prevent the scale formation is approximately 70° C. or ±70° C. It is also operable within the temperature ranges of 55-70° C., 70-120° C., or others to conduct the seawater desalinating process, but the comprehensive benefits thereof are poorer than at the temperature of ±70° C.

Advantages of the invention are as follows:

First, because a best temperature parameter to reach high efficiency of the solar thermal apparatus (the best operating parameter of the current solar thermal apparatus) is 275-395° C. (adopting the conduction oil as the medium) or 178-610° C. (adopting a molten salt as the medium), the high efficient heat transfer medium (such as the conduction oil, silicone oil, paraffin wax, and the molten salt) is adopted to satisfy the temperature operating parameters of the solar thermal apparatus, and the heat transfer medium is used to heat the seawater to approximately 70° C. Thus, the scale formation resulted from seawater heating directly by the solar thermal apparatus is avoided, both the seawater desalinating systems and the solar power filed operate at the best temperature parameters, thereby realizing efficiency for collecting the heat energy of the solar power to the utmost.

Second, the freshwater plant is generally required to continuously supply water for 24 hrs. The heat energy of the sunlight is stored by the heat transfer medium (such as the conduction oil, the silicone oil, the paraffin wax, and the molten salt), so that the seawater can be heated in nocturnal periods, and the freshwater is continuously produced.

Because of the highly efficient solar thermal apparatus is adopted, the multi-stage flash evaporator structures are capable of efficiently collecting the relatively dispersed solar energy and accomplish the heating and evaporation of the seawater. The desalinating rate of the seawater reaches 40%, and the solar energy can be stored to enable the seawater desalinating apparatus to continuously operate to produce the freshwater in nocturnal periods. The produced freshwater has good quality and reaches the standard of drinking water. Furthermore, the green solar energy is primarily utilized, so that the seawater desalinating process is environmentally friendly, high efficient with high yield.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An apparatus for desalinating seawater, comprising:
a) a seawater purifying system, the seawater purifying system comprising: a purified seawater transporting pump comprising a purified seawater output main pipe; and
b) a seawater desalinating system, the seawater desalinating system comprising: a solar thermal apparatus for concentrating solar energy and collecting heat, a solar energy heat storage tank, a purified seawater heater, a heated seawater pump, at least one stage of seawater flash evaporator, a freshwater main pipe, a sealed fresh water storage tank, a vacuum pump, and a concentrated brine pump; the solar thermal apparatus comprising a heat transfer medium chamber; the purified seawater heater comprising: a first heat exchanger utilizing a heat transfer medium as a heat source, an inlet, a seawater outlet, and an inlet main pipe; and each stage of seawater flash evaporator comprising a flash evaporator body and a seawater cooler; the flash evaporator body comprising: a concentrated brine outlet, a freshwater outlet, a vapor outlet, a throttling device comprising an inlet, and a condenser body comprising a seawater outlet; and the seawater cooler comprising: a second heat exchanger utilizing vapor as a heat source, and a seawater outlet;
wherein
the heat transfer medium chamber of the solar thermal apparatus, solar energy heat storage tank, the first heat exchanger of the purified seawater heater are connected in sequence to form a sealed route for circulating the heat transfer medium;
the purified seawater output main pipe of the purified seawater transporting pump communicates with the inlet of the purified seawater heater and the seawater cooler;
the seawater outlet of the purified seawater heater communicates with the inlet of the throttling device of the first-stage flash evaporator body via the heated seawater pump;
vapor discharged from the vapor outlet of the flash evaporator body passes through the second heat exchanger and combines with a freshwater in the freshwater main pipe; the sealed fresh water storage tank is disposed at an end of the freshwater main pipe and communicates with the vacuum pump; the concentrated brine outlet communicates with a pipe of a salt plant via the concentrated brine pump;
the seawater outlet of the seawater cooler communicates with the inlet main pipe of the purified seawater heater via the condenser body of the flash evaporator body;
when at least two stage seawater flash evaporators are employed, the purified seawater output main pipe communicates with the seawater outlets of the condenser bodies of each stage seawater flash evaporator;
the concentrated brine outlet of a former stage flash evaporator body communicates with the inlet of the throttling device of a next stage flash evaporator body, and the concentrated brine outlet of a last stage flash evaporator body communicates with the pipe of the salt plant via the concentrated brine pump; and
pressures in the flash evaporator bodies of each stage are gradually decreased whereby forming negative pressures.

2. The apparatus of claim 1, wherein
a heated seawater pump having adjustable rotational speed is disposed between the seawater outlet of the purified seawater heater and the flash evaporator body; the seawater outlet of the purified seawater heater communicates with the throttling device disposed on the flash evaporator body via the heated seawater pump, and the throttling device is disposed above a seawater surface in the flash evaporator body;
in the flash evaporator body, a foam breaker is disposed above the throttling device, a freshwater collecting disc is disposed above the foam breaker, and the condenser body is disposed on the freshwater collecting disc; and
the vapor outlet is disposed at a top of the flash evaporator body, and the freshwater outlet is disposed above the freshwater collecting disc, and the concentrated brine outlet is disposed beneath the throttling device.

3. The apparatus of claim 1, wherein a seawater temperature sensor and a spare heat exchanger are disposed in the purified seawater heater; and the spare heat exchanger adopts a thermal oil furnace, an electric heating furnace, exhaust heat of flue gas from a boiler, or exhaust heat of waste heat from a turbine as a heat source.

4. The apparatus of claim 2, wherein a seawater temperature sensor and a spare heat exchanger are disposed in the purified seawater heater; and the spare heat exchanger adopts a thermal oil furnace, an electric heating furnace, exhaust heat of flue gas from a boiler, or exhaust heat of waste heat from a turbine as a heat source.

5. The apparatus of claim 1, wherein a heat transfer medium pump is disposed between the solar energy heat storage tank and the first heat exchanger of the purified seawater heater.

6. The apparatus of claim 1, wherein the solar power filed is a tower type solar thermal collector, a parabolic trough type evacuated tubular collector, a glass type evacuated tubular collector, or a heat pipe type evacuated tubular collector.

7. The apparatus of claim 5, wherein the solar power filed is a tower type solar thermal collector, a parabolic trough type evacuated tubular collector, a glass type evacuated tubular collector, or a heat pipe type evacuated tubular collector.

8. The apparatus of claim 1, wherein
the seawater purifying system is a multi-stage purifying system comprising a seawater extraction well for coarse filtration, a seawater sterilizing clarifier, a multi-stage ultra-filter provided with an active carbon filter layer and a multi-fiber filter core layer, and a deoxygenating-decarbonizing tower for deoxygenation and decarbonization arranged in sequence;
a purified seawater tank is disposed between the multi-stage ultra-filter and the deoxygenating-decarbonizing tower; the deoxygenating-decarbonizing tower communicates with a purified seawater main outlet;
the seawater extraction well communicates with the seawater sterilizing clarifier via a seawater lifting pump; the seawater sterilizing clarifier communicates with the multi-stage ultra-filter via a first seawater transporting pump; the multi-stage ultra-filter communicates with the purified seawater tank via a second seawater transporting pump; the purified seawater tank communicates with the deoxygenating-decarbonizing tower via a third seawater transporting pump; the deoxygenating-decarbonizing tower communicates with the purified seawater main outlet via a purified seawater pump; and
the seawater sterilizing clarifier is added with a microbicide and a flocculant.

9. The apparatus of claim 1, wherein the seawater extraction well is constructed at a sea beach; a well opening is disposed above a sea level at the highest tide, and a well bottom is disposed multiple meters beneath a sea level at low tides; a well wall adopts a porous concrete structure, rubbles are arranged outside the well wall, and sands are filled in the periphery of the rubbles.

10. The apparatus of claim 8, wherein the seawater extraction well is constructed at a sea beach; a well opening is disposed above a sea level at the highest tide, and a well bottom is disposed multiple meters beneath a sea level at low tides; a well wall adopts a porous concrete structure, rubbles are arranged outside the well wall, and sands are filled in the periphery of the rubbles.

11. A method for desalinating seawater using the apparatus of claim 1, the method comprising:
1) multi-stage purifying the seawater to produce a purified seawater;
2) collecting solar energy by the solar thermal apparatus to heat the heat transfer medium whereby converting the solar energy into heat energy of the heat transfer medium; continuously heating the purified seawater to a preset temperature by the heat energy of the heat transfer medium, and transporting the heated purified seawater to at least one-stage flash evaporator for flash evaporation; and allowing pressures in the flash evaporator bodies of each stage to gradually decrease to form a negative pressure during the flash evaporation;
3) condensing a vapor after the flash evaporation to separate the freshwater, and converting remaining vapor into the freshwater by the seawater cooler; and
4) transporting a non-vaporized concentrated brine from a bottom of the flash evaporator to the salt plant;
wherein
when multi-stage flash evaporators are employed, the concentrated brine at the bottom of the former stage flash evaporator successively flow into a next stage flash evaporator, and the freshwater is gradually condensed and separated out during the multi-stage evaporation process, and the non-vaporized concentrated brine is transported to the salt plant; and
at the same time the heat energy of the sunlight is collected by the solar thermal apparatus and the heat transfer medium is utilized to heat the purified seawater, the heat energy of the heat transfer medium is stored in the solar energy heat storage tank so as to continuously heat the purified seawater using the stored heat transfer medium during nocturnal periods or cloudy days.

12. The method of claim 11, wherein the preset temperature of the purified seawater heated by the heat transfer medium is 55-70° C. or 70-120° C., and the heat transfer medium is heated to a temperature of 178-600° C. by the solar thermal apparatus.

13. The method of claim 11, wherein the preset temperature of the purified seawater heated by the heat transfer medium is approximately 70° C., and the heat transfer medium is heated to the temperature of 275-395° C. by the solar thermal apparatus.
